(19) United States
(12) Patent Application Publication
(10) Pub. No.: US 2013/0332972 A1
(43) Pub. Date: Dec. 12, 2013

(54) CONTEXT-AWARE VIDEO PLATFORM SYSTEMS AND METHODS

(71) Applicant: RealNetworks, Inc., Seattle, WA (US)

(72) Inventors: Joel JACOBSON, Seattle, WA (US); Philip SMITH, Seattle, WA (US); Phil AUSTIN, Maple Valley, WA (US); Senthil VAIYAPURI, Federal Way, WA (US); Satish KILARU, Seattle, WA (US); Ravishankar DHAMODARAN, Seattle, WA (US)

(21) Appl. No.: 13/916,505

(22) Filed: Jun. 12, 2013

Related U.S. Application Data
(60) Provisional application No. 61/658,766, filed on Jun. 12, 2012.

(51) Int. Cl. H04N 21/234

(52) U.S. Cl. CPC H04N 21/234
USPC 725/93

(57) ABSTRACT

A video-platform server may obtain and provide context-specific metadata to remote playback devices via an application programming interface. Context-specific metadata may include tags describing one or more assets (e.g., actors, locations, articles of clothing, business establishments, or the like) that are depicted in or otherwise associated with a given video segment.

### CROSS-REFERENCE TO RELATED APPLICATIONS

This application claims the benefit of priority to Provisional Patent Application No. 61/658,766, filed Jun. 12, 2012 under Attorney Docket No. REAL-2012395, titled “CONTEXTUAL ADVERTISING PLATFORM DISPLAY SYSTEMS AND METHODS”, and naming inventors Joel Jacobson et al. The above-cited application is hereby incorporated by reference, in its entirety, for all purposes.

### FIELD

The present disclosure relates to the field of computing, and more particularly, to a video platform server that obtains and serves contextual metadata to remote playback clients.

### BACKGROUND

In 1995, RealNetworks of Seattle, Wash. (then known as Progressive Networks) broadcast the first live event over the Internet, a baseball game between the Seattle Mariners and the New York Yankees. In the decades since, streaming media has become increasingly ubiquitous, and various business models have evolved around streaming media and advertising. Indeed, some analysts project that spending on on-line advertising will increase from $41B in 2012 to almost $68B in 2015, in part because many consumers enjoy consuming streaming media via laptops, tablets, set-top boxes, or other computing devices that potentially enable users to interact and engage with media in new ways.

For example, in some cases, consuming streaming media may give rise to numerous questions about the context presented by the streaming media. In response to viewing a given scene, a viewer may wonder “who is that actor?”, “what is that song?”, “where can I buy that jacket?”, or other like questions. However, existing streaming media services may not provide an API allowing playback clients to obtain and display contextual metadata and offer contextually relevant information to viewers as they consume streaming media.

### BRIEF DESCRIPTION OF THE DRAWINGS

FIG. 1 illustrates a contextual video platform system in accordance with one embodiment.

FIG. 2 illustrates several components of an exemplary video-platform server in accordance with one embodiment.

FIG. 3 illustrates an exemplary series of communications between video-platform server, partner device, and media-playback device that illustrate certain aspects of a contextual video platform, in accordance with one embodiment.

FIG. 4 illustrates a routine for providing a contextual video platform API, such as may be performed by a video-platform server in accordance with one embodiment.

FIG. 5 illustrates an exemplary context-aware media-rendering UI, such as may be provided by video-platform server and generated by media-playback device in accordance with one embodiment.

FIGS. 6-11 illustrate an exemplary context-aware media-rendering UI, such as may be provided by video-platform server and generated by media-playback device in accordance with one embodiment.

### DESCRIPTION

In various embodiments as described herein, a video-platform server may obtain and provide context-specific metadata to remote playback devices via an application programming interface. Context-specific metadata may include tags describing one or more assets (e.g., actors, locations, articles of clothing, business establishments, or the like) that are depicted in or otherwise associated with a given video segment.

The phrases “in one embodiment”, “in various embodiments”, “in some embodiments”, and the like are used repeatedly. Such phrases do not necessarily refer to the same embodiment. The terms “comprising”, “having”, and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

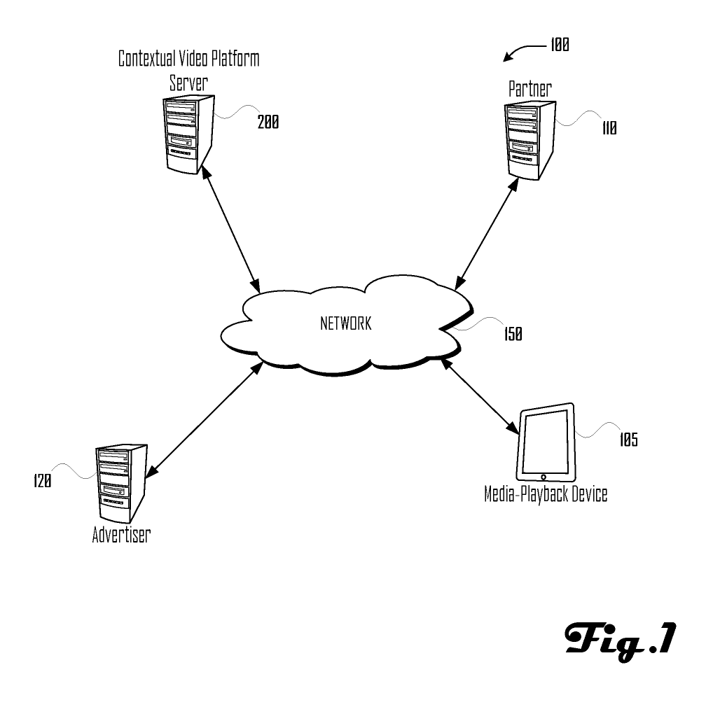

FIG. 1 illustrates a contextual video platform system in accordance with one embodiment. In the illustrated system, video-platform server 200, media-playback device 105, partner device 110, and advertiser device 120 are connected to network 150.

In various embodiments, video-platform server 200 may comprise one or more physical and/or logical devices that collectively provide the functionalities described herein. In some embodiments, video-platform server 200 may comprise one or more replicated and/or distributed physical or logical devices.

In some embodiments, video-platform server 200 may comprise one or more computing services provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

In various embodiments, partner device 110 may represent one or more devices operated by a content producer, owner, distributor, and/or other like entity that may have an interest in promoting viewer engagement with streamed media. In various embodiments, video-platform server 200 may provide facilities by which partner device 110 may add, edit, and/or otherwise manage asset definitions and context data associated with video segments, and by which media-playback device 105 may interact and engage with content such as described herein.

In various embodiments, advertiser device 120 may represent one or more devices operated by an advertiser, sponsor, and/or other like entity that may have an interest in promoting viewer engagement with streamed media. In various embodiments, video-platform server 200 may provide facilities by which partner device 110 may add, edit, and/or otherwise manage advertising campaigns and/or asset-based games.

In various embodiments, network 150 may include the Internet, a local area network (“LAN”), a wide area network (“WAN”), a cellular data network, and/or other data network. In various embodiments, media-playback device 105 may include a desktop PC, mobile phone, laptop, tablet, or other computing device that is capable of connecting to network 150 and rendering media data as described herein.

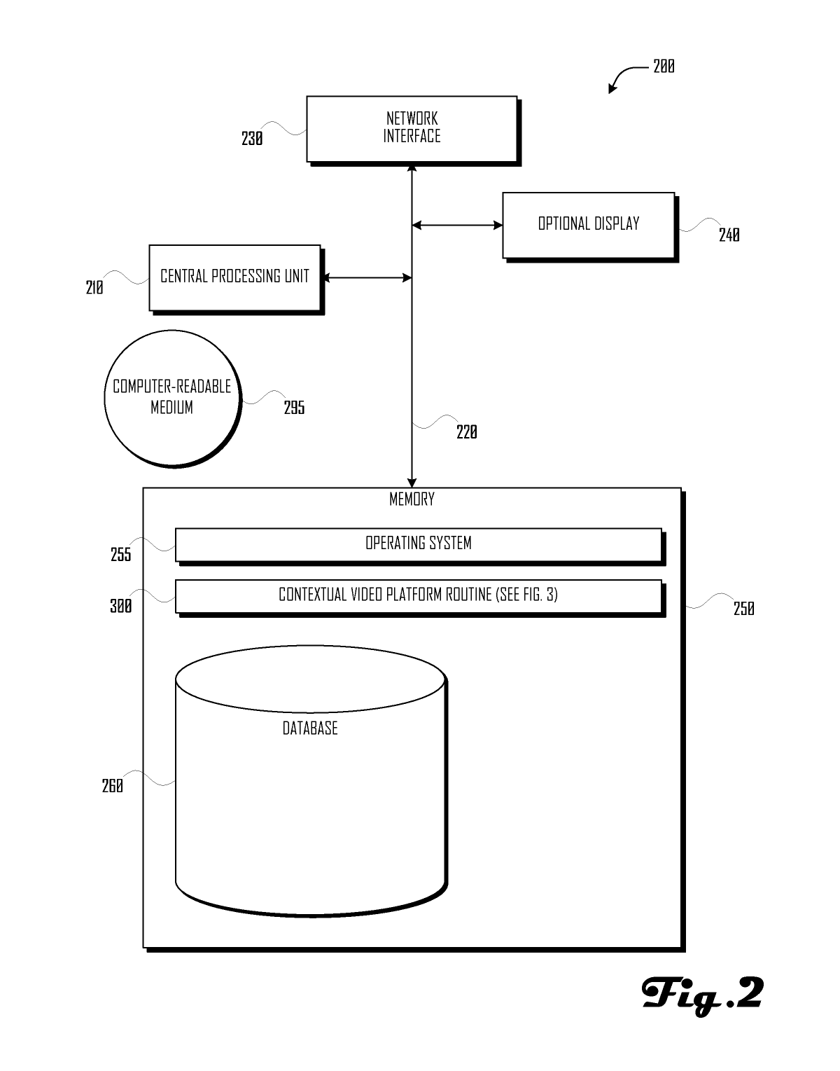

FIG. 2 illustrates several components of an exemplary video-platform server in accordance with one embodiment. In some embodiments, video-platform server 200 may include many more components than those shown in FIG. 2. However, it is not necessary that all of these generally conventional components be shown in order to disclose an illustrative embodiment.

Video-platform server 200 includes a bus 220 interconnecting components including a processing unit 210; a memory 250; optional display 240; input device 245; and network interface 230.

In various embodiments, input device 245 may include a mouse, track pad, touch screen, haptic input device, or other pointing and/or selection device.

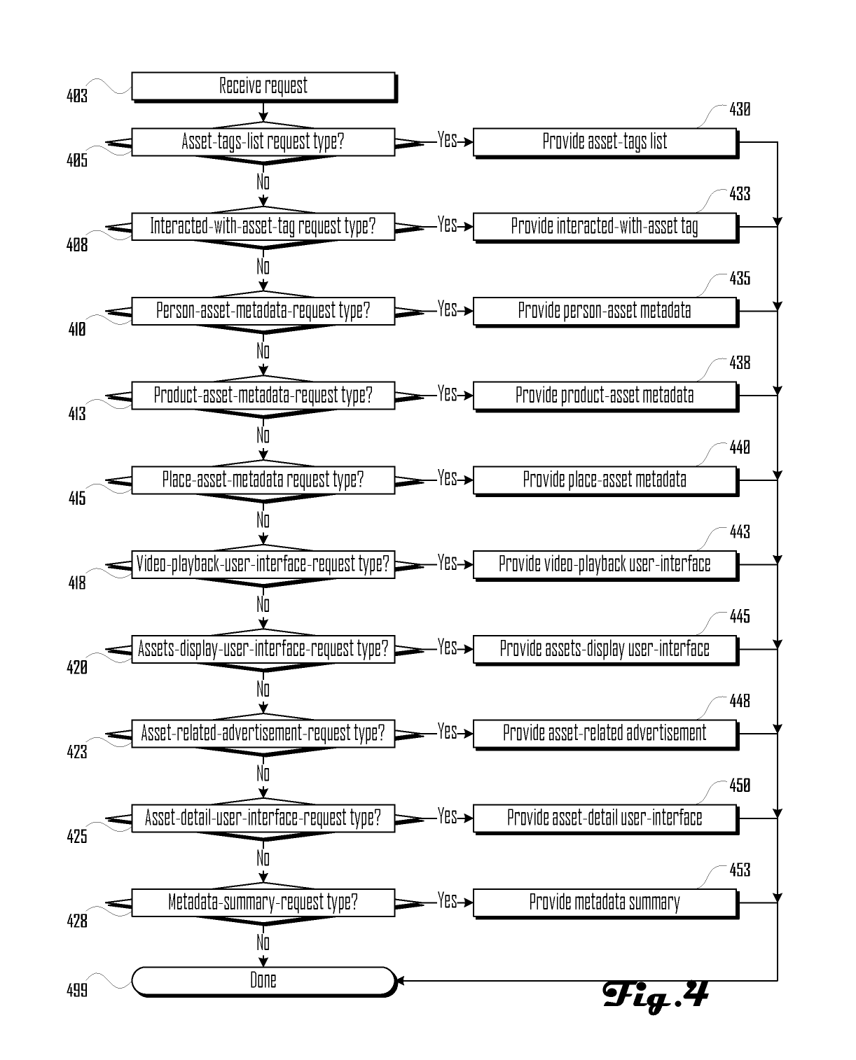

Memory 250 generally comprises a random access memory (“RAM”), a read only memory (“ROM”), and a permanent mass storage device, such as a disk drive. The memory 250 stores program code for a routine 400 for providing a contextual video platform API (see FIG. 4, discussed below). In addition, the memory 250 also stores an operating system 255.

These and other software components may be loaded into memory 250 of video-platform server 200 using a drive mechanism (not shown) associated with a non-transient computer readable storage medium 295, such as a floppy disc, tape, DVD/CD-ROM drive, memory card, or the like. In some embodiments, software components may alternately be loaded via the network interface 230, rather than via a non-transient computer readable storage medium 295.

Memory 250 also includes database 260, which stores records including records 265A-D.

In some embodiments, video-platform server 200 may communicate with database 260 via network interface 230, a storage area network (“SAN”), a high-speed serial bus, and/or via the other suitable communication technology.

In some embodiments, database 260 may comprise one or more storage services provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

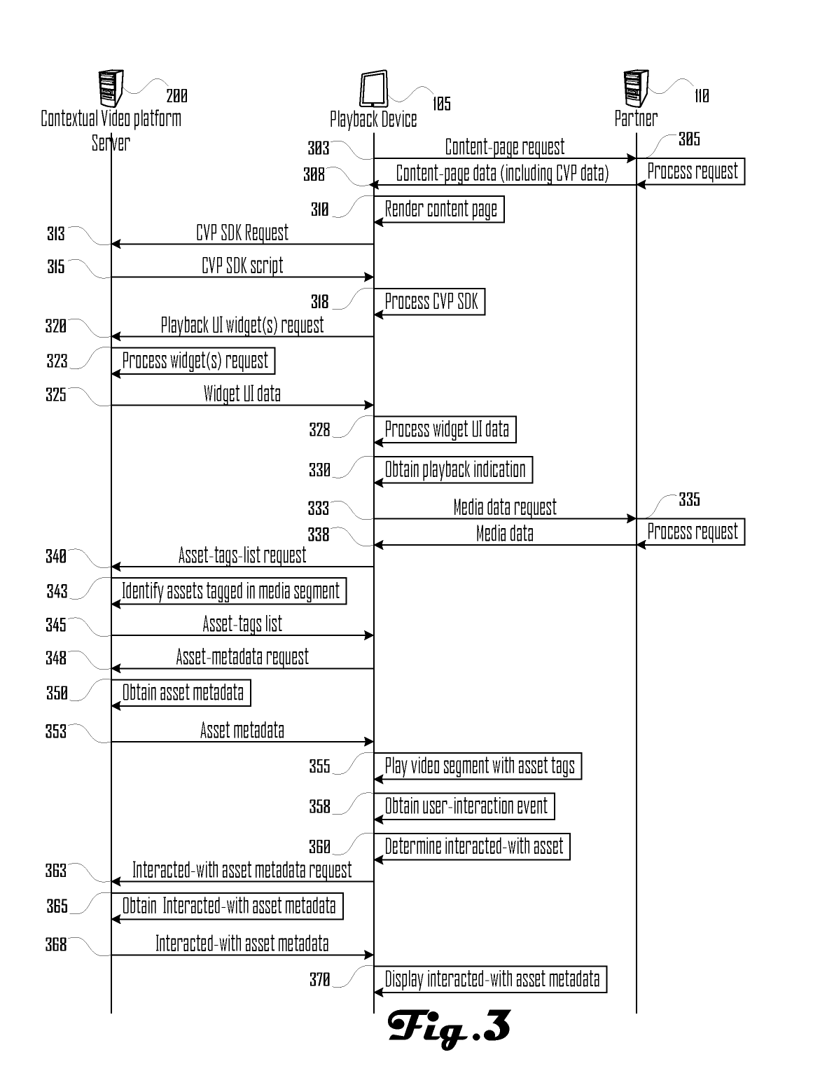

FIG. 3 illustrates an exemplary series of communications between video-platform server 200, partner device 110, and media-playback device 105 that illustrate certain aspects of a contextual video platform, in accordance with one embodiment.

Beginning the illustrated series of communications, media-playback device 105 sends to partner device 110 a request 303 for a content page hosted or otherwise provided by partner device 110, the content page including context-aware video playback and interaction facilities. Partner device 110 processes 305 the request and sends to media-playback device 105 data 308 corresponding to the requested content page, the data including one or more references (e.g. a uniform resource locator or “URL”) to scripts or similarly functional resources provided by video-platform server 200.

For example, in one embodiment, data 308 may include a page of hypertext markup language (“HTML”) including an HTML tag similar to the following.

<script id=“cvp_sdk” type=“text/javascript” src=“http://cvp-
web.videoplatform.com/public/sdk/v1/cvp_sdk.js”></script>

Using the data 308 provided by partner device 110, media-playback device 105 begins the process of rendering 310 the content page, in the course of which, media-playback device 105 sends to video-platform server 200 a request 313 for one or more scripts or similarly functional resources referenced in data 308. Video-platform server 200 sends 315 the requested script(s) or similarly functional resource(s) to media-playback device 105 for processing 318 in the course of rendering the content page.

For example, in one embodiment, media-playback device 105 may instantiate one or more software objects that expose properties and/or methods by which media-playback device 105 may access a contextual-video application programming interface (“API”) provided by video-platform server 200. In such embodiments, such an instantiated software object may mediate some or all of the subsequent communication between media-playback device 105 and video-platform server 200 as described below.

While still rendering the content page, media-playback device 105 sends to video-platform server 200 a request 320 for scripts or similarly functional resources and/or data to initialize a user interface (“UI”) “widget” for controlling the playback of and otherwise interacting with a media file displayed on the content page. The term “widget” is used herein to refer to a functional element (e.g., a UI, including one or more controls) that may be instantiated by a web browser or other application on a media-playback device to enable functionality such as that described herein.

Video-platform server 200 processes 323 the request and sends to media-playback device 105 data 325, which media-playback device 105 processes 328 to instantiate the requested UI widget(s). For example, in one embodiment, the instantiated widget(s) may include playback controls to enable a user to control playback of a media file. Media-playback device 105 obtains, via the instantiated UI widget(s), an indication 330 to begin playback of a media file on the content page. In response, media-playback device 105 sends to partner device 110 a request 333 for renderable media data corresponding to at least a segment of the media file. Partner device 110 processes 335 the request and sends to media-playback device 105 the requested renderable media data 338.

Typically, renderable media data includes computer-processable data derived from a digitized representation of a piece of media content, such as a video or other multimedia presentation. The renderable media data send to media-playback device 105 may include less than all of the data required to render the entire duration of the media presentation. For example, in one embodiment, the renderable media data may include a segment (e.g. 30 or 60 seconds) within a longer piece of content (e.g., a 22 minute video presentation).

In other embodiments, the renderable media data may be hosted by and obtained from a third party media hosting service, such as YouTube.com, provided by Google, Inc. of Menlo Park, Calif. (“YouTube”).

In the course or preparing to render the media data, media-playback device 105 sends to video-platform server 200 a request 340 for a list of asset identifiers identifying assets that are depicted in or otherwise associated with a given segment of the media presentation. In response, video-platform server 200 identifies 343 one or more asset tags corresponding to assets that are depicted in or otherwise associated with the media segment.

As the term is used herein, “assets” refer to objects, items, actors, and other entities that are depicted in or otherwise associated with a video segment. For example, within a given 30-second scene, the actor “Art Arterton” may appear during the time range from 0-15 seconds, the actor “Betty Bing” may appear during the time range 12-30 seconds, the song “Pork Chop” may play in the soundtrack during the time range from 3-20 seconds, and a particular laptop computer may appear during the time range 20-30 seconds. In various embodiments, some or all of these actors, songs, and objects may be considered “assets” that are depicted in or otherwise associated with the video segment.

Video-platform server 200 sends to media-playback device 105 a list 345 of identifiers identifying one or more asset tags corresponding to one or more assets that are depicted in or otherwise associated with the media segment. For some or all of the identified asset tags, media-playback device 105 sends to video-platform server 200 a request 348 for asset “tags” corresponding to the list of identifiers.

As the term is used herein, an asset “tag” refers to a data structure including an identifier and metadata describing an asset's relationship to a given media segment. For example, an asset tag may specify that a particular asset is depicted at certain positions within the video frame at certain times during presentation of a video.

Video-platform server 200 obtains 350 (e.g., from database 260) the requested asset tag metadata and sends 353 it to media-playback device 105. For example, in one embodiment, video-platform server 200 may send one or more data structures similar to the following.

Asset ID: d13b7e51ec93
Media ID: 5d0b431d63f1
Asset Type: Person
AssetControl: /asset/d13b7e51ec93/thumbnail.jpg
Asset Context Data: “http://en.wikipedia.org/wiki/Art_Arterton”
Time Start: 15
Time End: 22.5
Coordinates: [0.35, 0.5]

To facilitate human comprehension, this and other example data objects depicted herein are presented according to version 1.2 of the YAML “human friendly data serialization standard”, specified at http://www.yaml.org/spec/1.2/spec.html. In practice, data objects may be serialized for storage and/or transmission into any suitable format (e.g., YAML, JSON, XML, BSON, Property Lists, or the like).

Using the data thereby provided, media-playback device 105 plays 355 the video segment, including presenting asset metadata about assets that are currently depicted in or otherwise associated with the media segment.

In the course of playing the video segment, media-playback device 105 obtains an indication 358 that a user has interacted with a tagged asset. For example, in some embodiments, media-playback device 105 may obtain an indication from an integrated touchscreen, mouse, or other pointing and/or selection device that the user has touched, clicked-on, or otherwise selected a particular point or area within the rendered video frame.

Media-playback device 105 determines 360 (e.g., using asset-position tag metadata) that the interaction event corresponds to a particular asset that is currently depicted in or otherwise associated with the media segment, and media-playback device 105 sends to video-platform server 200 a request 363 for additional metadata associated with the interacted-with asset.

Video-platform server 200 obtains 365 (e.g. from database 260) additional metadata associated with the interacted-with asset and sends the metadata 368 to media-playback device 105 for display 370. For example, in one embodiment, such additional metadata may include detailed information about an asset, and may include URLs or similar references to external resources that include even more detailed information.

FIG. 4 illustrates a routine 400 for providing a contextual video platform API, such as may be performed by a video-platform server 200 in accordance with one embodiment.

In block 403, routine 400 receives a request from a media-playback device 105. In various embodiments, routine 400 may accept requests of a variety of request types, similar to (but not limited to) those described below. The examples provided below use Javascript syntax and assume the existence of an instantiated contextual video platform (“CVP”) object in a web browser or other application executing on a remote client device.

In decision block 405, routine 400 determines whether the request (as received in block 403) is of an asset-tags-list request type. If so, then routine 400 proceeds to block 430. Otherwise, routine 400 proceeds to decision block 408.

For example, in one embodiment, routine 400 may receive a request based on a remote-client invocation of a method that is used to retrieve the video tags for the specified time period for a video id and distributor account id, such as a “get_tag_data” method (see, e.g., Appendix F). In such an embodiment, the remote client may send the request by invoking the method with parameters similar to some or all of the following.

CVP.get_tag_data(video_id, start_time, end_time, dist_id,
callback, parse_json)

Responsive to the asset-tags-list request received in block 403 and the determination made in decision block 405, routine 400 provides the requested asset-tags list to the requesting device in block 430.

For example, in one embodiment, routine 400 may provide data such as that shown in Appendix F.

In decision block 408, routine 400 determines whether the request (as received in block 403) is of an interacted-with-asset-tag request type. If so, then routine 400 proceeds to block 433. Otherwise, routine 400 proceeds to decision block 410.

For example, in one embodiment, routine 400 may receive a request based on a remote-client invocation of a method that is used to retrieve the asset information around a user click/touch event on the remote client, such as a “get_tag_from_event” method (see, e.g., Appendix G). In such an embodiment, the remote client may send the request by invoking the method with parameters similar to some or all of the following.

CVP.get_tag_from_event(dist_id, video_id, time, center_x,
center_y, callback, parse_json)

Responsive to the interacted-with-asset-tag request received in block 403 and the determination made in decision block 408, routine 400 provides the requested interacted-with-asset tag to the requesting device in block 433.

For example, in one embodiment, routine 400 may provide data such as that shown in Appendix G.

In decision block 410, routine 400 determines whether the request (as received in block 403) is of a person-asset-metadata-request type. If so, then routine 400 proceeds to block 435. Otherwise, routine 400 proceeds to decision block 413.

For example, in one embodiment, routine 400 may receive a request based on a remote-client invocation of a method that is used to retrieve the asset information for a person asset id and distributor account id, such as a “get_person_data” method (see, e.g., Appendix C). In such an embodiment, the remote client may send the request by invoking the method with parameters similar to some or all of the following.
CVP.get_person_data(person_id, dist_id, callback, parse_json)

Responsive to the person-asset-metadata request received in block 403 and the determination made in decision block 410, routine 400 provides the requested person-asset metadata to the requesting device in block 435.

For example, in one embodiment, routine 400 may provide data such as that shown in Appendix C.

In decision block 413, routine 400 determines whether the request (as received in block 403) is of a product-asset-metadata-request type. If so, then routine 400 proceeds to block 438. Otherwise, routine 400 proceeds to decision block 415.

For example, in one embodiment, routine 400 may receive a request based on a remote-client invocation of a method that is used to retrieve the asset information for a product asset id and distributor account id, such as a “get_product_data” method (see, e.g., Appendix D). In such an embodiment, the remote client may send the request by invoking the method with parameters similar to some or all of the following.
CVP.get_product_data(product_id, dist_id, callback, parse_json)

Responsive to the product-asset-metadata request received in block 403 and the determination made in decision block 413, routine 400 provides the requested product-asset metadata to the requesting device in block 438.

For example, in one embodiment, routine 400 may provide data such as that shown in Appendix D.

In decision block 415, routine 400 determines whether the request (as received in block 403) is of a place-asset-metadata request type. If so, then routine 400 proceeds to block 440. Otherwise, routine 400 proceeds to decision block 418.

For example, in one embodiment, routine 400 may receive a request based on a remote-client invocation of a method that is used to retrieve the asset information for a place asset id and for a distributor account id, such as a “get_place_data” method (see, e.g., Appendix E). In such an embodiment, the remote client may send the request by invoking the method with parameters similar to some or all of the following.
CVP.get_place_data(place_id, dist_id, callback, parse_json)

Responsive to the place-asset-metadata request received in block 403 and the determination made in decision block 415, routine 400 provides the requested place-asset metadata to the requesting device in block 440.

For example, in one embodiment, routine 400 may provide data such as that shown in Appendix E.

In decision block 418, routine 400 determines whether the request (as received in block 403) is of a video-playback-user-interface-request type. If so, then routine 400 proceeds to block 443. Otherwise, routine 400 proceeds to decision block 420.

For example, in one embodiment, routine 400 may receive a request based on a remote-client invocation of a method that initializes the remote client & adds necessary event listeners for the player widget, such as an “init_player” method (see, e.g., Appendix AF). In such an embodiment, the remote client may send the request by invoking the method with parameters similar to some or all of the following.
CVP.init_player( )

For example, in another embodiment, routine 400 may receive a request based on a remote-client invocation of a method that initializes the video meta data, assets and tags data and exposes them as global CVP variables (CVP.video_data, CVP.assets, CVP.tags), such as an “init_data” method (see, e.g., Appendix R). In such an embodiment, the remote client may send the request by invoking the method with parameters similar to some or all of the following.
CVP.init_data(videoid, distributionid)

Responsive to the video-playback-user-interface request received in block 403 and the determination made in decision block 418, routine 400 provides the requested video-playback-user interface to the requesting device in block 443.

In decision block 420, routine 400 determines whether the request (as received in block 403) is of an assets-display-user-interface-request type. If so, then routine 400 proceeds to block 445. Otherwise, routine 400 proceeds to decision block 423.

For example, in one embodiment, routine 400 may receive a request based on a remote-client invocation of a method that initializes & adds necessary event listeners and displays the reel widget, such as an “init_reel_widget” method (see, e.g., Appendix W). In such an embodiment, the remote client may send the request by invoking the method with parameters similar to some or all of the following.
CVP.init_reel_widget(parent_id)

For example, in another embodiment, routine 400 may receive a request based on a remote-client invocation of a method that creates/displays slivers based on the remote client current time, such as a “new_sliver” method (see, e.g., Appendix X). In such an embodiment, the remote client may send the request by invoking the method with parameters similar to some or all of the following.
CVP.new_sliver(player_time)

Responsive to the assets-display-user-interface request received in block 403 and the determination made in decision block 420, routine 400 provides the requested assets-display-user interface to the requesting device in block 445.

In decision block 423, routine 400 determines whether the request (as received in block 403) is of an asset-related-advertisement-request type. If so, then routine 400 proceeds to block 448. Otherwise, routine 400 proceeds to decision block 425.

For example, in one embodiment, routine 400 may receive a request based on a remote-client invocation of a method that is used to retrieve advertisement for an asset which has an ad campaign associated with it, such as a “get_advertisement” method (see, e.g., Appendix H). In such an embodiment, the remote client may send the request by invoking the method with parameters similar to some or all of the following.
CVP.get_advertisement(dist_id, campaign_id, zone_id, callback)

Responsive to the asset-related-advertisement request received in block 403 and the determination made in decision block 423, routine 400 provides the requested asset-related advertisement to the requesting device in block 448.

In decision block 425, routine 400 determines whether the request (as received in block 403) is of an asset-detail-user-interface-request type. If so, then routine 400 proceeds to block 450. Otherwise, routine 400 proceeds to decision block 428.

For example, in one embodiment, routine 400 may receive a request based on a remote-client invocation of a method that initializes & adds necessary event listeners for the details widget, such as an “init_details_panel” method (see, e.g., Appendix AC). In such an embodiment, the remote client may send the request by invoking the method with parameters similar to some or all of the following.
CVP.init_details_panel (parent_id)

For example, in another embodiment, routine 400 may receive a request based on a remote-client invocation of a method that displays detailed information on an asset. It also displays several tabs like wiki, twitter etc. to pull more information on the asset from other external resources, such as a “display_details_panel” method (see, e.g., Appendix AD). In such an embodiment, the remote client may send the request by invoking the method with parameters similar to some or all of the following.
CVP.display_details_panel (asset_id, campaign_id)

Responsive to the asset-detail-user-interface request received in block 403 and the determination made in decision block 425, routine 400 provides the requested asset-detail-user interface to the requesting device in block 450.

In decision block 428, routine 400 determines whether the request (as received in block 403) is of a metadata-summary-request type. If so, then routine 400 proceeds to block 450. Otherwise, routine 400 proceeds to ending block 499.

For example, in one embodiment, routine 400 may receive a request based on a remote-client invocation of a method that is used to get the video metadata summary for a video id and distributor account id, such as a “get_video_data” method (see, e.g., Appendix B). In such an embodiment, the remote client may send the request by invoking the method with parameters similar to some or all of the following.
CVP.get_video_data(video_id, dist_id, callback, parse_json)

Responsive to the metadata-summary request received in block 403 and the determination made in decision block 428, routine 400 provides the requested metadata summary to the requesting device in block 450.

For example, in one embodiment, routine 400 may provide data such as that shown in Appendix B.

Routine 400 ends in ending block 499.

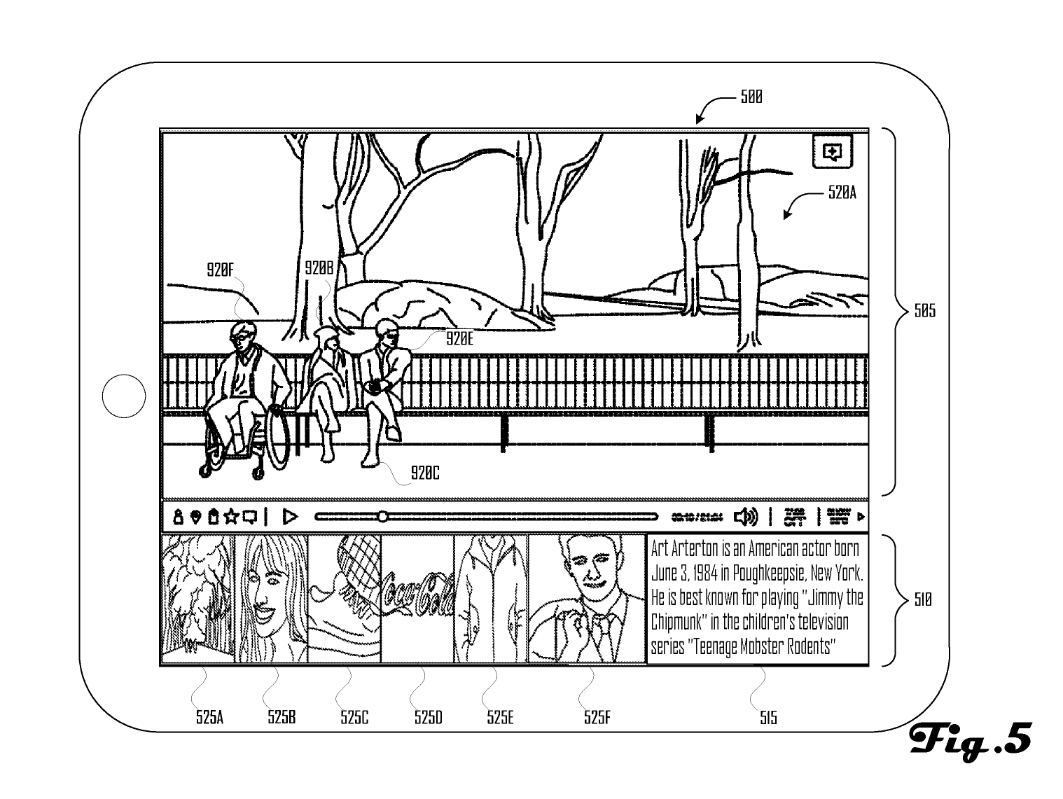

FIG. 5 illustrates an exemplary context-aware media-rendering UI, such as may be provided by video-platform server 200 and generated by media-playback device 105 in accordance with one embodiment.

UI 500 includes media-playback widget 505, in which renderable media data is rendered. The illustrated media content presents a scene in which three individuals are seated on or near a bench in a park-like setting. Although not apparent from the illustration, the individuals in the rendered scene may be considered for explanatory purposes to be discussing popular mass-market cola beverages.

UI 500 also includes assets widget 510, in which currently-presented asset controls 525A-F are displayed. In particular, asset control 525A corresponds to location asset 520A (the park-like location in which the current scene takes place). Similarly, asset control 525B and asset control 525F correspond respectively to person asset 520B and person asset 520F (two of the individuals currently presented in the rendered scene); asset control 525C and asset control 525E correspond respectively to object asset 520C and object asset 520E (articles of clothing worn by an individual currently presented in the rendered scene); and asset control 525D corresponds to object asset 520D (the subject of a conversation taking place in the currently presented scene).

The illustrated media content also presents other elements (e.g., a park bench, a wheelchair, et al) that are not represented in assets widget 510, indicating that those elements may not be associated with any asset metadata.

Assets widget 510 has been configured to present context-data display 515. In various embodiments, such a configuration may be initiated if the user activates an asset control (e.g., asset control 525F) and/or selects an asset (e.g., person asset 520F) as displayed in media-playback widget 505. In some embodiments, context-data display 515 or a similar widget may be used to present promotional content while the video is rendered in media-playback widget 505.

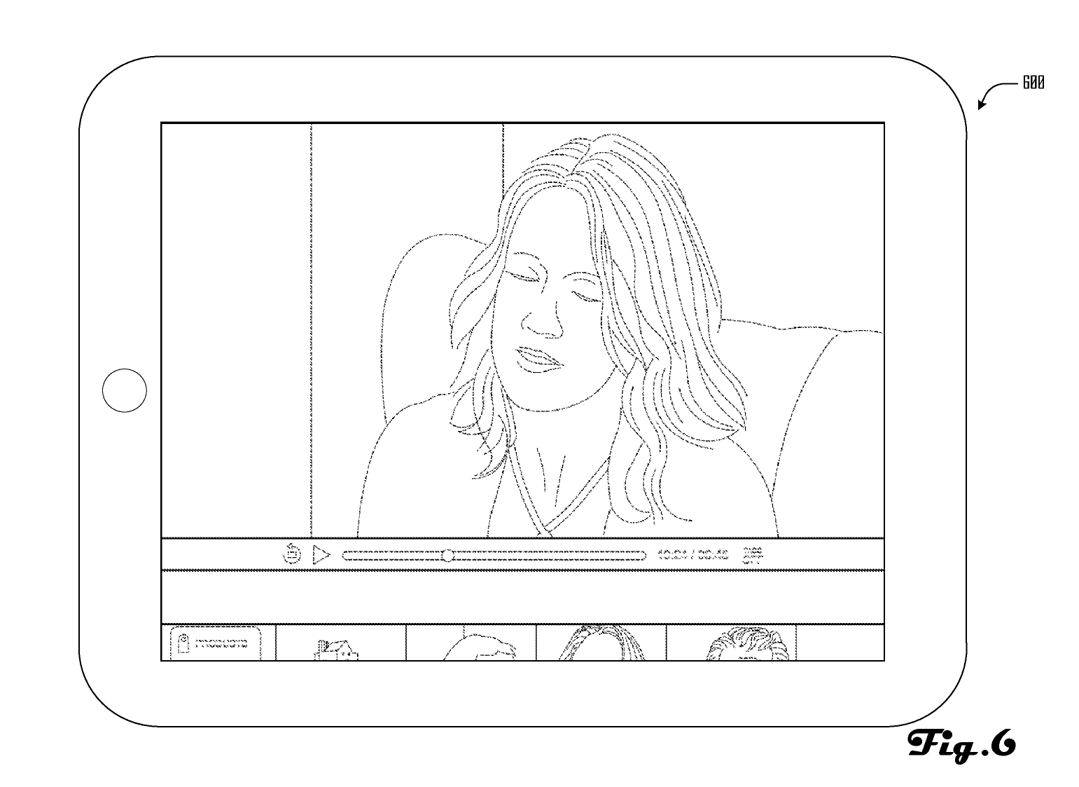

FIG. 6 illustrates an exemplary context-aware media-rendering UI, such as may be provided by video-platform server 200 and generated by media-playback device 105 in accordance with one embodiment.

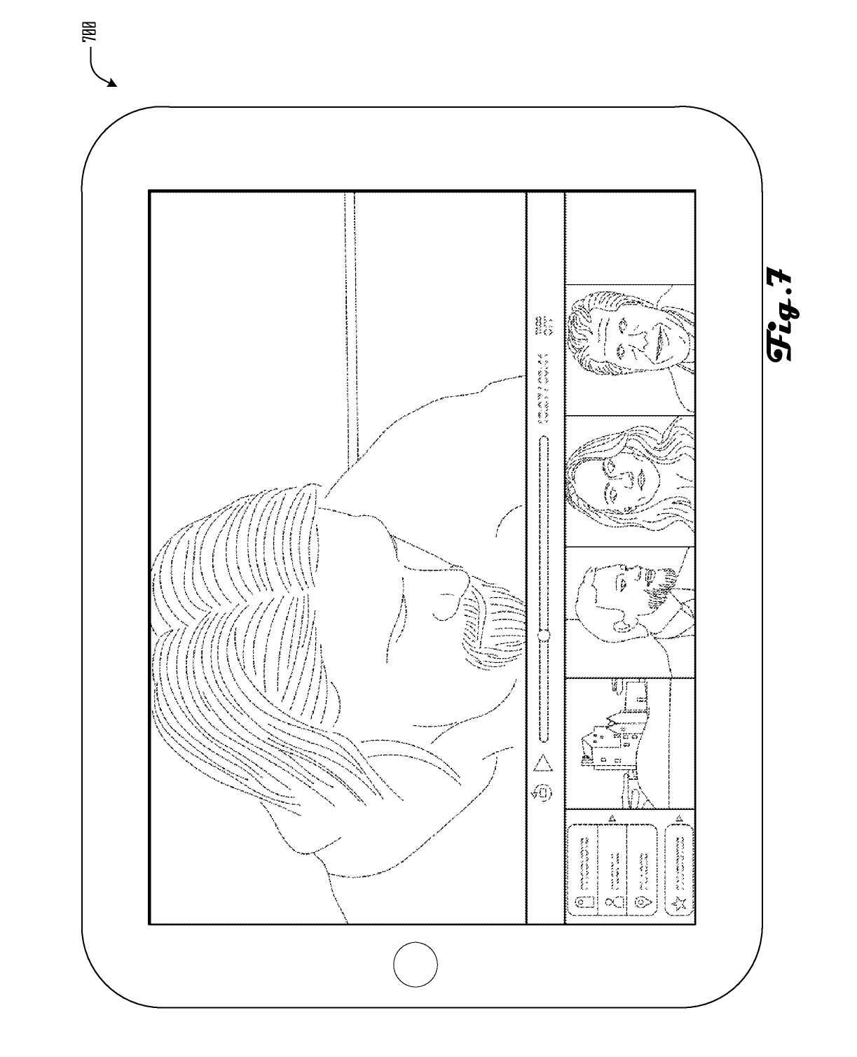

FIG. 7 illustrates an exemplary context-aware media-rendering UI, such as may be provided by video-platform server 200 and generated by media-playback device 105 in accordance with one embodiment.

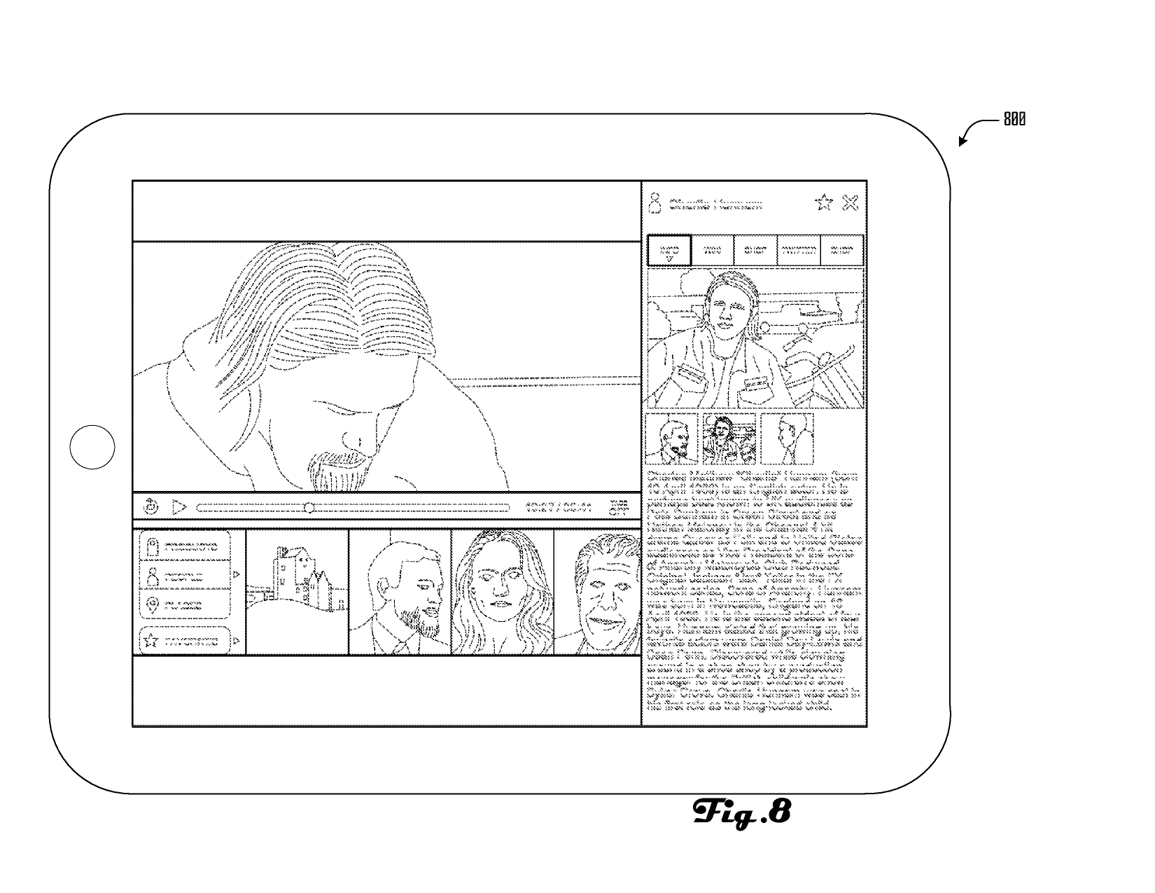

FIG. 8 illustrates an exemplary context-aware media-rendering UI, such as may be provided by video-platform server 200 and generated by media-playback device 105 in accordance with one embodiment.

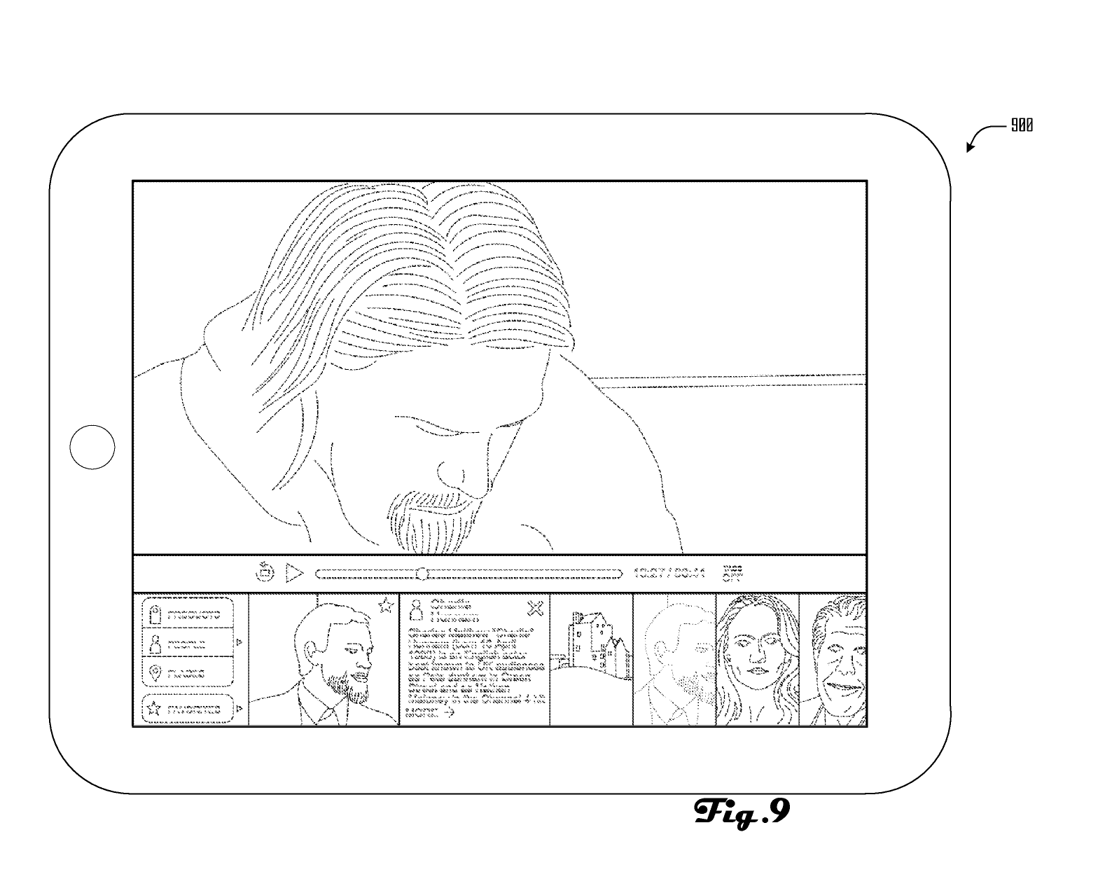

FIG. 9 illustrates an exemplary context-aware media-rendering UI, such as may be provided by video-platform server 200 and generated by media-playback device 105 in accordance with one embodiment.

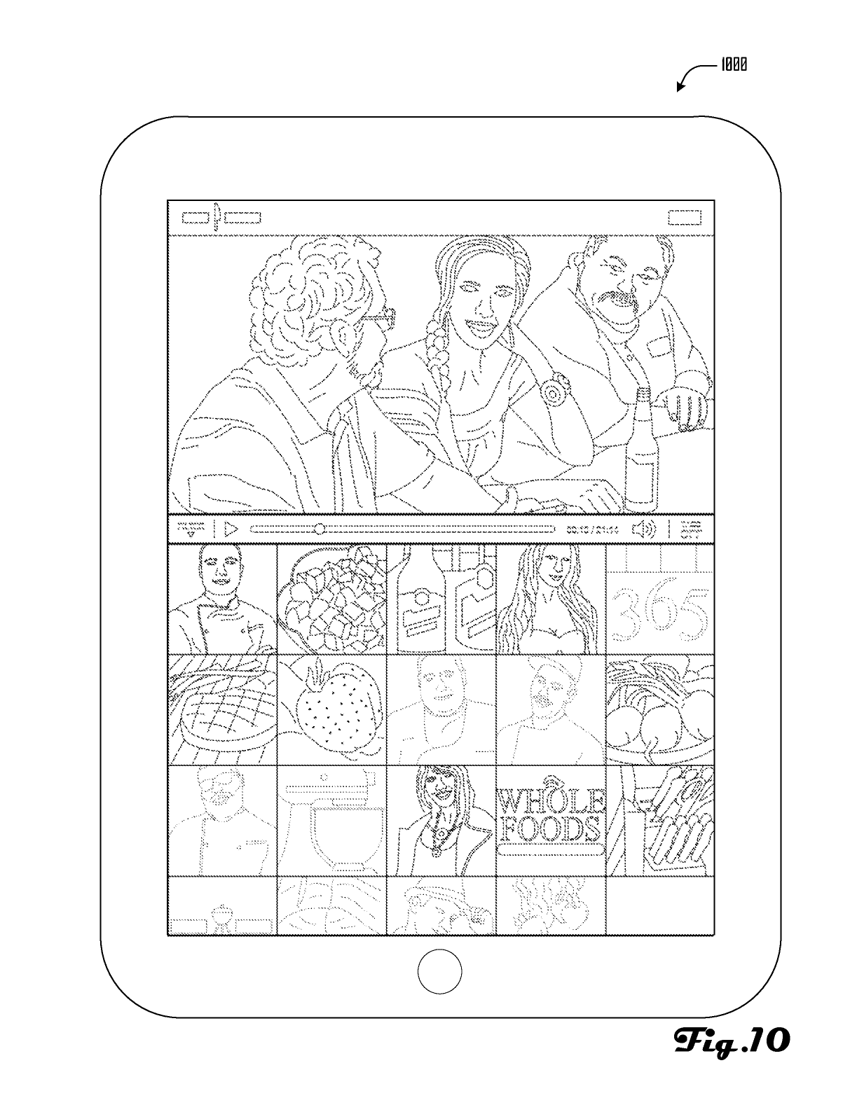

FIG. 10 illustrates an exemplary context-aware media-rendering UI, such as may be provided by video-platform server 200 and generated by media-playback device 105 in accordance with one embodiment.

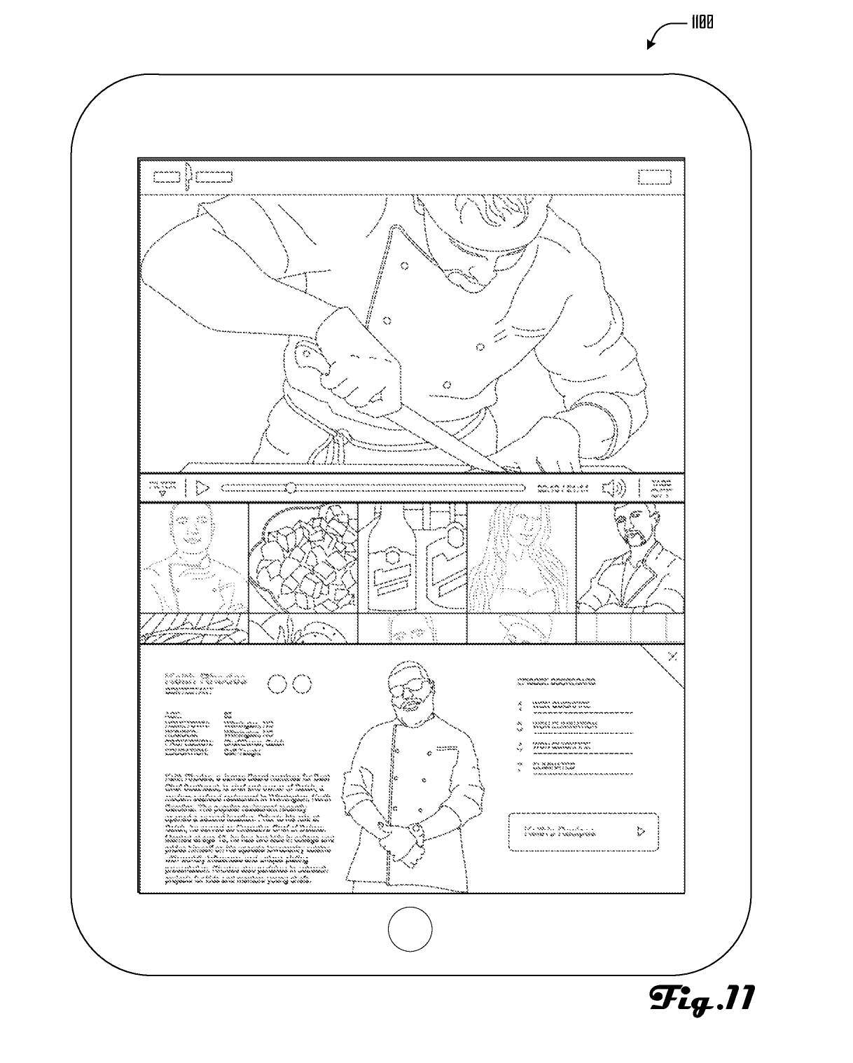

FIG. 11 illustrates an exemplary context-aware media-rendering UI, such as may be provided by video-platform server 200 and generated by media-playback device 105 in accordance with one embodiment.

Appendices A-Q illustrate an exemplary set of methods associated with an exemplary Data Library Widget. In various embodiments, a data library widget (cvp_data_lib.js) provides APIs to invoke CVP Server-side APIs to get Video Information, Asset Data (Product, Place, People), Tag Data, Advertisement information and for Reporting.

Appendices R-V illustrate an exemplary set of methods associated with an exemplary Data Handler Widget. In various embodiments, a Data Handler widget invokes the public APIs defined in data library widget and exposes CVP methods and variables for accessing video metadata summary, asset and tags information.

Appendices W-Z, AA, and AB illustrate an exemplary set of methods associated with an exemplary Reel Widget. In various embodiments, a Reel widget displays the asset sliver tags based on current player time & features a menu to filter assets by Products, People & Places.

Appendices AC, AD, and AE illustrate an exemplary set of methods associated with an exemplary Details Widget. In various embodiments, a Details widget displays detailed information of an asset.

Appendices AF, AG, and AH illustrate an exemplary set of methods associated with an exemplary Player Widget. In various embodiments, a Player widget displays video player and controls (e.g., via HTML5). The init public method defined in cvp_sdk.js (Loading SDK) takes an input parameter (initParams) which specifies the widgets to initialize. To initialize the player widget, player_widget parameter should be set as follows to specify the type (html5), video id, distributor account id, media type and media key. Start time and end time are optional for seek/pause video at specified time intervals.

Appendices AI, AJ, AK, AL, and AM illustrate an exemplary set of methods associated with an exemplary Player Interface Widget. In various embodiments, a Player interface widget serves as an interface between the player and app, and defines the event listener functions for various events such as click, meta data has loaded, video ended, video error & time update (player current time has changed).

Although specific embodiments have been illustrated and described herein, it will be appreciated by those of ordinary skill in the art that alternate and/or equivalent implementations may be substituted for the specific embodiments shown and described without departing from the scope of the present disclosure. This application is intended to cover any adaptations or variations of the embodiments discussed herein.

1. A video-platform-server-implemented method for providing an application programming interface for providing contextual metadata about an indicated video, the method comprising:
accepting, by the video-platform server from a remote playback device, requests of a plurality of request types, including an asset-metadata-request type, an asset-tags-list request type, and an interacted-with-asset-tag request type;
responsive to an asset-tags-list request of said asset-tags-list request type, providing, by the video-platform server, an asset-tags list comprising a plurality of asset tags associated with an indicated segment of the indicated video and an indicated distributor account, said plurality of asset tags corresponding respectively to a plurality of assets that are depicted during or otherwise associated with said indicated segment of the indicated video;
responsive to an asset-metadata request of said asset-metadata-request type, providing, by the video-platform server, asset metadata associated with an indicated asset and said indicated distributor account, said indicated asset being depicted during or otherwise associated with the indicated video; and
responsive to an interacted-with-asset-tag request of said interacted-with-asset-tag request type, providing, by the video-platform server, an interacted-with asset tag comprising an asset tag that corresponds to an indicated user-interaction event, the indicated video, and said indicated distributor account.

2. The method of claim 1, wherein each asset tag of said plurality of asset tags comprises time-line data indicating one or more temporal portions of the indicated video during which each asset tag is depicted or otherwise associated with the indicated video.

3. The method of claim 2, wherein each asset tag of said plurality of asset tags further comprises time-line spatial data indicating one or more spatial regions within which each asset tag is depicted during said one or more temporal portions of the indicated video.

4. The method of claim 1, wherein said asset-metadata-request type comprises:
a person-asset-metadata-request type; and
wherein providing said asset metadata associated with said indicated asset further comprises:
providing person-asset metadata associated with an indicated person asset and said indicated distributor account, said indicated person asset being depicted during or otherwise associated with the indicated video.

5. The method of claim 1, wherein said asset-metadata-request type comprises:
a place-asset-metadata request type; and
wherein providing said asset metadata associated with said indicated asset further comprises:
providing place-asset metadata associated with an indicated place asset and said indicated distributor account, said indicated place asset being depicted during or otherwise associated with the indicated video.

6. The method of claim 1, wherein said asset-metadata-request type comprises:
a product-asset-metadata-request type; and
wherein providing said asset metadata associated with said indicated asset further comprises:
providing product-asset metadata associated with an indicated product asset and said indicated distributor account, said indicated product asset being depicted during or otherwise associated with the indicated video.

7. The method of claim 1, wherein said plurality of request types further comprises:
a video-playback-user-interface-request type; and
wherein the method further comprises:
responsive to a video-playback-user-interface request of said video-playback-user-interface-request type, providing a user interface configured to control playback of and enable user-interaction with the indicated video, including enabling a remote user to select some or all of said plurality of assets that are depicted during or otherwise associated with said indicated segment of the indicated video.

8. The method of claim 1, wherein said plurality of request types further comprises:
an assets-display-user-interface-request type; and
wherein the method further comprises:
responsive to an assets-display-user-interface request of said assets-display-user-interface-request type, providing a user interface configured to display and enable user-interaction with some or all of said plurality of assets that are depicted during or otherwise associated with said indicated segment of the indicated video.

9. The method of claim 1, wherein said plurality of request types further comprises:
an asset-related-advertisement-request type; and
wherein the method further comprises:
responsive to an asset-related-advertisement request of said asset-related-advertisement-request type, providing an asset-related advertisement corresponding to said indicated distributor account and an indicated advertisement campaign.

10. The method of claim 1, wherein said plurality of request types further comprises:
an asset-detail-user-interface-request type; and
wherein the method further comprises:
responsive to an asset-detail-user-interface request of said asset-detail-user-interface-request type, providing a user interface configured to display details associated with and enable user-interaction with an indicated one of said plurality of assets that are depicted during or otherwise associated with said indicated segment of the indicated video.

11. The method of claim 1, wherein said plurality of request types further comprises:
a metadata-summary-request type; and
wherein the method further comprises:
responsive to a metadata-summary request of said metadata-summary-request type, providing a metadata summary summarizing metadata associated with a plurality of videos corresponding to said indicated distributor account, including the indicated video.

12. A computing apparatus for providing an application programming interface for providing contextual metadata about an indicated video, the apparatus comprising a processor and a memory storing instructions that, when executed by the processor, configure the apparatus to:
accept, from a remote playback device, requests of a plurality of request types, including an asset-metadata-request type, an asset-tags-list request type, and an interacted-with-asset-tag request type;
responsive to an asset-tags-list request of said asset-tags-list request type, provide an asset-tags list comprising a plurality of asset tags associated with an indicated segment of the indicated video and an indicated distributor account, said plurality of asset tags corresponding respectively to a plurality of assets that are depicted during or otherwise associated with said indicated segment of the indicated video;
responsive to an asset-metadata request of said asset-metadata-request type, provide asset metadata associated with an indicated asset and said indicated distributor account, said indicated asset being depicted during or otherwise associated with the indicated video; and
responsive to an interacted-with-asset-tag request of said interacted-with-asset-tag request type, provide an interacted-with asset tag comprising an asset tag that corresponds to an indicated user-interaction event, the indicated video, and said indicated distributor account.

13. The apparatus of claim 12, wherein each asset tag of said plurality of asset tags comprises time-line data indicate one or more temporal portions of the indicated video during which each asset tag is depicted or otherwise associated with the indicated video.

14. The apparatus of claim 13, wherein each asset tag of said plurality of asset tags further comprises time-line spatial data indicate one or more spatial regions within which each asset tag is depicted during said one or more temporal portions of the indicated video.

15. The apparatus of claim 12, wherein said asset-metadata-request type comprises:
a person-asset-metadata-request type; and
wherein providing said asset metadata associated with said indicated asset further comprises configuring the apparatus to:
provide person-asset metadata associated with an indicated person asset and said indicated distributor account, said indicated person asset being depicted during or otherwise associated with the indicated video.

16. The apparatus of claim 12, wherein said asset-metadata-request type comprises:
a place-asset-metadata request type; and
wherein providing said asset metadata associated with said indicated asset further comprises configuring the apparatus to:
provide place-asset metadata associated with an indicated place asset and said indicated distributor account, said indicated place asset being depicted during or otherwise associated with the indicated video.

17. The apparatus of claim 12, wherein said asset-metadata-request type comprises:
a product-asset-metadata-request type; and
wherein providing said asset metadata associated with said indicated asset further comprises configuring the apparatus to:
provide product-asset metadata associated with an indicated product asset and said indicated distributor account, said indicated product asset being depicted during or otherwise associated with the indicated video.

18. The apparatus of claim 12, wherein said plurality of request types further comprises:
a video-playback-user-interface-request type; and
wherein the instructions further comprise instructions that configure the apparatus to:
responsive to a video-playback-user-interface request of said video-playback-user-interface-request type, provide a user interface configured to control playback of and enable user-interaction with the indicated video, including enabling a remote user to select some or all of said plurality of assets that are depicted during or otherwise associated with said indicated segment of the indicated video.

19. The apparatus of claim 12, wherein said plurality of request types further comprises:
an assets-display-user-interface-request type; and
wherein the instructions further comprise instructions that configure the apparatus to:
responsive to an assets-display-user-interface request of said assets-display-user-interface-request type, provide a user interface configured to display and enable user-interaction with some or all of said plurality of assets that are depicted during or otherwise associated with said indicated segment of the indicated video.

20. A non-transient computer-readable storage medium having stored thereon instructions that, when executed by a processor, configure the processor to:
accept, from a remote playback device, requests of a plurality of request types, including an asset-metadata-request type, an asset-tags-list request type, and an interacted-with-asset-tag request type;
responsive to an asset-tags-list request of said asset-tags-list request type, provide an asset-tags list comprising a plurality of asset tags associated with an indicated segment of an indicated video and an indicated distributor account, said plurality of asset tags corresponding respectively to a plurality of assets that are depicted during or otherwise associated with said indicated segment of the indicated video;
responsive to an asset-metadata request of said asset-metadata-request type, provide asset metadata associated with an indicated asset and said indicated distributor account, said indicated asset being depicted during or otherwise associated with the indicated video; and
responsive to an interacted-with-asset-tag request of said interacted-with-asset-tag request type, provide an interacted-with asset tag comprising an asset tag that corresponds to an indicated user-interaction event, the indicated video, and said indicated distributor account.

21. The storage medium of claim 20, wherein each asset tag of said plurality of asset tags comprises time-line data indicate one or more temporal portions of the indicated video during which each asset tag is depicted or otherwise associated with the indicated video.

22. The storage medium of claim 21, wherein each asset tag of said plurality of asset tags further comprises time-line spatial data indicate one or more spatial regions within which each asset tag is depicted during said one or more temporal portions of the indicated video.

23. The storage medium of claim 20, wherein said asset-metadata-request type comprises:
a person-asset-metadata-request type; and
wherein providing said asset metadata associated with said indicated asset further comprises configuring the processor to:
provide person-asset metadata associated with an indicated person asset and said indicated distributor account, said indicated person asset being depicted during or otherwise associated with the indicated video.

24. The storage medium of claim 20, wherein said asset-metadata-request type comprises:
a place-asset-metadata request type; and
wherein providing said asset metadata associated with said indicated asset further comprises configuring the processor to:
provide place-asset metadata associated with an indicated place asset and said indicated distributor account, said indicated place asset being depicted during or otherwise associated with the indicated video.

25. The storage medium of claim 20, wherein said asset-metadata-request type comprises:
a product-asset-metadata-request type; and
wherein providing said asset metadata associated with said indicated asset further comprises configuring the processor to:
provide product-asset metadata associated with an indicated product asset and said indicated distributor account, said indicated product asset being depicted during or otherwise associated with the indicated video.

26. The storage medium of claim 20, wherein said plurality of request types further comprises:
a video-playback-user-interface-request type; and
wherein the instructions further comprise instructions that configure the processor to:
responsive to a video-playback-user-interface request of said video-playback-user-interface-request type, provide a user interface configured to control playback of and enable user-interaction with the indicated video, including enabling a remote user to select some or all of said plurality of assets that are depicted during or otherwise associated with said indicated segment of the indicated video.

27. The storage medium of claim 20, wherein said plurality of request types further comprises:
an assets-display-user-interface-request type; and
wherein the instructions further comprise instructions that configure the processor to:
responsive to an assets-display-user-interface request of said assets-display-user-interface-request type, provide a user interface configured to display and enable user-interaction with some or all of said plurality of assets that are depicted during or otherwise associated with said indicated segment of the indicated video.
